(19) United States
(12) Patent Application Publication
(10) Pub. No.: US 2023/0099919 A1
(43) Pub. Date: Mar. 30, 2023

(54) SYSTEM AND METHOD FOR STOCHASTIC FULL WAVEFORM INVERSION

(71) Applicant: Chevron U.S.A. Inc., San Ramon, CA (US)

(72) Inventors: Jinsong Chen, Santa Clara, CA (US); Uwe K. Albertin, Houston, TX (US); Kurt T. Nihei, Houston, TX (US); Sam T. Kaplan, Houston, TX (US); Gary Michael Hoversten, Lafayette, CA (US); Lin Zhang, Houston, TX (US); Dimitri Bevc, Houston, TX (US)

(21) Appl. No.: 17/279,375

(22) PCT Filed: Mar. 15, 2021
(86) PCT No.: PCT/IB2021/052113

§ 371 Date: Mar. 24, 2021

Related U.S. Application Data
(60) Provisional application No. 63/000,594, filed on Mar. 27, 2020.

(51) Int. Cl. G01V 1/28; G01V 1/34; G01V 1/30

(52) U.S. Cl. CPC G01V 1/282; G01V 1/34; G01V 1/30; G01V 2210/66

(57) ABSTRACT

A method is described for generating a subsurface model using stochastic full waveform inversion by receiving a seismic dataset representative of a subsurface volume of interest; performing stochastic full waveform inversion of the seismic dataset to generate a long wavelength subsurface model; and performing full waveform inversion of the seismic dataset using the long wavelength subsurface model as a starting model to generate an improved subsurface model. The method may further include performing seismic imaging of the seismic dataset using the improved subsurface model to generate a seismic image and identifying geologic features based on the seismic image. The method may be executed by a computer system.

### CROSS-REFERENCE TO RELATED APPLICATIONS

This application is a national stage application, filed under 35 U.S.C. § 371, of International Patent Application No. PCT/IB2021/052113, filed on Mar. 15, 2021, which claims the benefit of U.S. Provisional Patent Application No. 63/000,594, filed Mar. 27, 2020.

### STATEMENT REGARDING FEDERALLY SPONSORED RESEARCH OR DEVELOPMENT

Not applicable.

### TECHNICAL FIELD

The disclosed embodiments relate generally to techniques for stochastic full waveform inversion of seismic data representative of subsurface reservoirs.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

The seismic data may be processed in many ways to allow interpretation and characterization of the subsurface volume of interest. Full waveform inversion (FWI) of band-limited seismic data has been increasingly used for seismic imaging in the last two decades. It has been shown to be capable of effectively recovering high-resolution velocity models when the starting velocity model is such that observed data and the synthetic data are aligned within half-a-cycle (i.e., not cycle-skipped). Current methods for full-waveform seismic inversion are dominated by gradient-based nonlinear optimization solvers. Those methods can be very efficient in finding optimal solutions of inverse problems when the initial model is close to the global optimal solution, but they can converge prematurely to a local solution when the data are cycle-skipped.

Since FWI's inception, many efforts have been made to reduce FWI's dependency on the initial model by modification of the objective function, such as multi-scale, windowed cross-correlation, matching filter, optimal transport, and Laplace/Laplace-Fourier domain methods. Although some of these methods have improved FWI's performance, modification of the objective function alone has not yet solved the problem.

Another direction for improving FWI is to improve the long wavelength starting model that allows the low frequency observed and synthetic data to match within a cycle. For example, ray-based reflection tomography methods have become standard model-building tools since the 1990s for estimating long-wavelength velocity models. Reflection tomography methods find the velocity model by minimizing residual move-out (RMO), i.e., the depth variations of reflection events across multiple offsets. Another commonly used method for estimating starting models is first arrival travel time tomography (FATT). FATT methods typically use finite-difference solution of Eikonal equation to calculate travel-times from first arrival waves. Some studies suggest that very low frequencies and very large offsets are required to obtain reliable FWI results when starting model is built by FATT.

Stochastic methods have also been used for estimating seismic background velocity models. Unlike local search approaches based on linearization and nonlinear gradient optimization, stochastic methods can find global solutions, while additionally providing uncertainty quantification. One of earliest examples defined the inverse problem of estimating 2D seismic background models as the exploration of the posterior probability distribution given seismic data by Monte Carlo sampling. Although their parameterization is simple and they only ran a few hundreds of iterations due to the limits of computing power in the early 1990s, they successfully demonstrated that stochastic inversion with Monte Carlo sampling can be a very powerful approach for providing a global solution with uncertainty information around the solution. Along the same line, we present a stochastic full waveform inversion (SWI) approach that uses a hierarchical Bayesian model with MCMC sampling for estimating long-wavelength starting models for FWI.

The ability to define the location of rock and fluid property changes in the subsurface with uncertainty quantifications is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for improved full waveform inversion methods that will allow better seismic interpretation of potential hydrocarbon reservoirs.

### SUMMARY

In accordance with some embodiments, a method of stochastic full waveform inversion is disclosed. The method may include receiving a seismic dataset representative of a subsurface volume of interest; performing stochastic full waveform inversion of the seismic dataset to generate a long wavelength subsurface model; performing full waveform inversion of the seismic dataset using the long wavelength subsurface model as a starting model to generate an improved subsurface model; performing seismic imaging of the seismic dataset using the improved subsurface model to generate a seismic image; and identifying geologic features based on the seismic image. In an embodiment, the stochastic full waveform inversion includes at least one of low-dimensional model parameterization, a Bayesian model, and Markov Chain Monte Carlo (MCMC) sampling strategies. In an embodiment, the low-dimensional model parameterization is selected from one of wavelet or other kernel basis parameterization, frequency domain parameterization, hierarchical parameterization with multiple types of auxiliary variables, or hybrid parameterization by combining different types of parameterization. In an embodiment, the Bayesian model is based on a type of likelihood function that best describes information in the seismic dataset by using different transformation or preconditioning on the seismic dataset. In an embodiment, the Markov Chain Monte Carlo sampling is a sampling method that will speed up convergence of chains selected from one of single-sit or blockwise Metropolis-Hastings sampling, slice sampling, Gibbs sampling, or parallelized Metropolis coupled Markov chain Monte Carlo sampling.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1A illustrates a true synthetic salt model;

FIG. 1B illustrates a standard full waveform inversion (FWI) result from a water-over-half space model;

FIG. 2A illustrates a stochastic full waveform inversion (SWI) result from the water-over-half space model using full band of seismic data;

FIG. 2B illustrates a stochastic full waveform inversion (SWI) result from the water-over-half space model using band-limited (2-15 Hz) seismic data;

FIG. 3A illustrates a standard full waveform inversion (FWI) result from the SWI estimated starting model obtained using full-band seismic data;

FIG. 3B illustrates a standard full waveform inversion (FWI) result from the SWI estimated starting model obtained using band-limited seismic data; and

FIG. 4 is a block diagram illustrating a full waveform inversion system, including both stochastic and standard full waveform inversion, in accordance with some embodiments.

Like reference numerals refer to corresponding parts throughout the drawings.

### DETAILED DESCRIPTION OF EMBODIMENTS

Described below are methods, systems, and computer readable storage media that provide a manner of full waveform inversion. These embodiments are designed to be of particular use for seismic imaging of subsurface volumes in geologically complex areas.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Advantageously, those of ordinary skill in the art will appreciate, for example, that the embodiments provided herein may be utilized to generate a more accurate digital seismic image (i.e., the corrected digital seismic image). The more accurate digital seismic image may improve hydrocarbon exploration and improve hydrocarbon production. The more accurate digital seismic image may provide details of the subsurface that were illustrated poorly or not at all in traditional seismic images. Moreover, the more accurate digital seismic image may better delineate where different features begin, end, or any combination thereof. As one example, the more accurate digital seismic image may illustrate faults and/or salt flanks more accurately. As another example, assume that the more accurate digital seismic image indicates the presence of a hydrocarbon deposit. The more accurate digital seismic image may delineate more accurately the bounds of the hydrocarbon deposit so that the hydrocarbon deposit may be produced.

Those of ordinary skill in the art will appreciate, for example, that the more accurate digital seismic image may be utilized in hydrocarbon exploration and hydrocarbon production for decision making. For example, the more accurate digital seismic image may be utilized to pick a location for a wellbore. Those of ordinary skill in the art will appreciate that decisions about (a) where to drill one or more wellbores to produce the hydrocarbon deposit, (b) how many wellbores to drill to produce the hydrocarbon deposit, etc. may be made based on the more accurate digital seismic image. The more accurate digital seismic image may even be utilized to select the trajectory of each wellbore to be drilled. Moreover, if the delineation indicates a large hydrocarbon deposit, then a higher number of wellbore locations may be selected and that higher number of wellbores may be drilled, as compared to delineation indicating a smaller hydrocarbon deposit.

Those of ordinary skill in the art will appreciate, for example, that the more accurate digital seismic image may be utilized in hydrocarbon exploration and hydrocarbon production for control. For example, the more accurate digital seismic image may be utilized to steer a tool (e.g., drilling tool) to drill a wellbore. A drilling tool may be steered to drill one or more wellbores to produce the hydrocarbon deposit. Steering the tool may include drilling around or avoiding certain subsurface features (e.g., faults, salt diapirs, shale diapirs, shale ridges, pockmarks, buried channels, gas chimneys, shallow gas pockets, and slumps), drilling through certain subsurface features (e.g., hydrocarbon deposit), or any combination thereof depending on the desired outcome. As another example, the more accurate digital seismic image may be utilized for controlling flow of fluids injected into or received from the subsurface, the wellbore, or any combination thereof. As another example, the more accurate digital seismic image may be utilized for controlling flow of fluids injected into or received from at least one hydrocarbon producing zone of the subsurface. Chokes or well control devices, positioned on the surface or downhole, may be used to control the flow of fluid into and out. For example, certain subsurface features in the more accurate digital seismic image may prompt activation, deactivation, modification, or any combination thereof of the chokes or well control devices so as control the flow of fluid. Thus, the more accurate digital seismic image may be utilized to control injection rates, production rates, or any combination thereof.

Those of ordinary skill in the art will appreciate, for example, that the more accurate digital seismic image may be utilized to select completions, components, fluids, etc. for a wellbore. A variety of casing, tubing, packers, heaters, sand screens, gravel packs, items for fines migration, etc. may be selected for each wellbore to be drilled based on the more accurate digital seismic image. Furthermore, one or more recovery techniques to produce the hydrocarbon deposit may be selected based on the more accurate digital seismic image.

In short, those of ordinary skill in the art will appreciate that there are many decisions (e.g., in the context of (a) steering decisions, (b) landing decisions, (c) completion decisions, (d) engineering control systems and reservoir monitoring in the following but not limited to: Tow Streamer, Ocean Bottom Sensor, VSP, DASVSP, and imaging with both primaries and free surface multiple, etc.) to make in the hydrocarbon industry and making proper decisions based on more accurate digital seismic images should improve the likelihood of safe and reliable operations. For simplicity, the many possibilities, including wellbore location, component selection for the wellbore, recovery technique selection, controlling flow of fluid, etc., may be collectively referred to as managing a subsurface reservoir.

The present invention includes embodiments of a method and system for full waveform inversion. This method first performs a stochastic full waveform inversion (SWI) to produce a long wavelength model that is then used as a starting model for standard full waveform inversion (FWI).

### Low-Dimensional Model Parameterization

Since our goal is to estimate long-wavelength velocity starting models for FWI, we adopt a coarse-scale model parameterization. In an embodiment, we parameterize the SWI model with Gaussian radial basis functions (RBF); note that the forward simulation is still carried out in the fine-scale domain, which is obtained by adjoint reconstruction from the RBF model. RBF methods have been used in geophysical applications to reduce the space dimension, e.g., scattered data interpolation, seismic finite-difference modeling, and FWI salt reconstruction.

For a 2D model, we first divide the region into nₓ and n_{z} grid locations along the x and z directions, respectively. We use these grid points, {(xᵢ, zⱼ): i=1, 2, . . . , nₓ, j=1, 2, . . . , n_{z}}, as the center locations of radial Gaussian basis functions. Seismic parameters (i.e., velocities) on the fine grid scale are obtained by adjoint reconstruction from Gaussian basis functions centered at those sites as follows:

m(x,z)=Σᵢ₌₁ⁿ^{ₓ}Σⱼ₌₁ⁿ^{_{z}}θᵢⱼφ(∥(x,z)−(xᵢ,zⱼ)∥). (1)

In equation 1, m(x, z) is P-wave velocity at location (x, z), which is the input to acoustic forward modeling. The symbol θⱼ is a coefficient or weight that represents the model in the radial basis, and φ( ) is a Gaussian radial basis function. This process may be thought of as the adjoint of projection of the fine scale model onto the RBF basis. The Gaussian radial basis functions are determined a-priori in this study; thus, our inversion parameters are their coefficients. For simplicity, we let symbol θ be a vector representing all those coefficients sorted by their indices.

### Bayesian Model

The data used in this study are multiple shot-gathers, each containing many receivers. Define d={dᵢⱼₜ}, where i, j, and t correspond to source, receiver, and time step, respectively, to be the field data, and G={Gᵢⱼₜ}, which is a function of the parameter vector θ to be the forward modeled data in the MCMC process. To take account of discrepancies between the simulated and measured data or errors in seismic data, we add a random vector. Therefore, we have that the modeled data d=G(θ+ε). We assume the random vector ε has a Gaussian distribution with independent components that have a common inverse variance of τ; thus, we can define the following likelihood function, which is the linkage between data and unknown variables.

$$f ( d \vert θ , τ ) = {\prod }_{i} {\prod }_{j} {\prod }_{t} \frac{{τ}^{0.5}}{\sqrt{2 π}} exp \{ - 0.5 {τ [ {d}_{ijt} - {G}_{ijt} ( θ ) ]}^{2} \} . \qquad ( 2 )$$

Within the Bayesian framework, we can incorporate knowledge from other sources through the definition of priors for the unknown variables. In this study, we assume each coefficient parameter has a uniform distribution defined in a large range, and thus, these parameters are mainly determined by their likelihood functions. However, we assume the inverse variance i has a Gamma distribution with given shape and rate parameter, and hence in determining i we use a Gibbs sampler. Mathematically, we have the following Bayesian model:

f(θ,τ|d)=C×f(d|θ,τ)×f(θ)×f(τ). (3)

In the above equation, C is a normalizing constant and it does not affect the solution.

The Bayesian model is based on a type of likelihood functions that best describe information in seismic data by using different transformation or preconditioning on original seismic data. In fact, all those transformations used in standard FWI can be incorporated into the Bayesian model in a form of likelihood function.

### Markov Chain Monte Carlo Sampling

Since our joint posterior probability distribution is high dimensional and complex, we use a Markov chain Monte Carlo (MCMC) method to draw many samples from it. The key to success for the inversion is to develop an efficient MCMC sampling algorithm that requires fewer forward modeling runs. Conventional Metropolis-Hastings sampling methods require time-consuming parameter tuning. In practice, we often need to develop problem-specific efficient sampling strategies.

For this study, we use the blockwise Metropolis-Hastings method to draw samples. Starting from current sample θ^{(k)}, where k=1, 2, . . . , N, and N is a preset total number of iterations, we first draw a candidate vector θ* uniformly around the current sample, and then accept it according to the following probability:

$$r = min \{ 1. , \frac{f ( d \vert {θ}^{*} , {τ}^{( k )} )}{f ( d \vert {θ}^{( k )} , {τ}^{( k )} )} \} . \qquad ( 4 )$$

Notice that we do not include prior and proposal distributions in the above formula. This is because we assume the prior is uniformly distributed within a given range; the proposal distribution is symmetric around the current value.

We use a different method to draw samples of the inverse variance since we can analytically draw samples from f(τ|⋅). Let RSS(θ) be the residual sum of squares, which is given below:

RSS(θ)=ΣᵢΣⱼΣₜ[dᵢⱼₜ−Gᵢⱼₜ(θ)]². (5)

Let the prior distribution f(τ)˜Gamma(α,λ). Thus, we have f(τ|⋅)˜Gamma(α+0.5 m, λ+0.5 RSS(θ)). Since both the total number of data points m and the residual sum of squares RSS(θ) are typically very large, the inverse variance is primarily determined by data misfits.

The sampling procedures consist of four main steps:
(1) Assign initial parameters θ⁽⁰⁾ and τ⁽⁰⁾ and set k=0;
(2) Draw sample θ^{(k)} from f(θ|⋅) given θ^{(k-1)} and τ^{(k-1)} using the blockwise Metropolis-Hastings method;
(3) Draw sample τ^{(k)} given θ^{(k)} and τ^{(k-1)} using Gibbs sampler;
(4) Increase iteration by one and check if the total number of iterations are equal to a present number. If the maximum number of iterations are reached, stop; otherwise, go to Step (2).

The given initial values affect the speed of convergence but not the results.

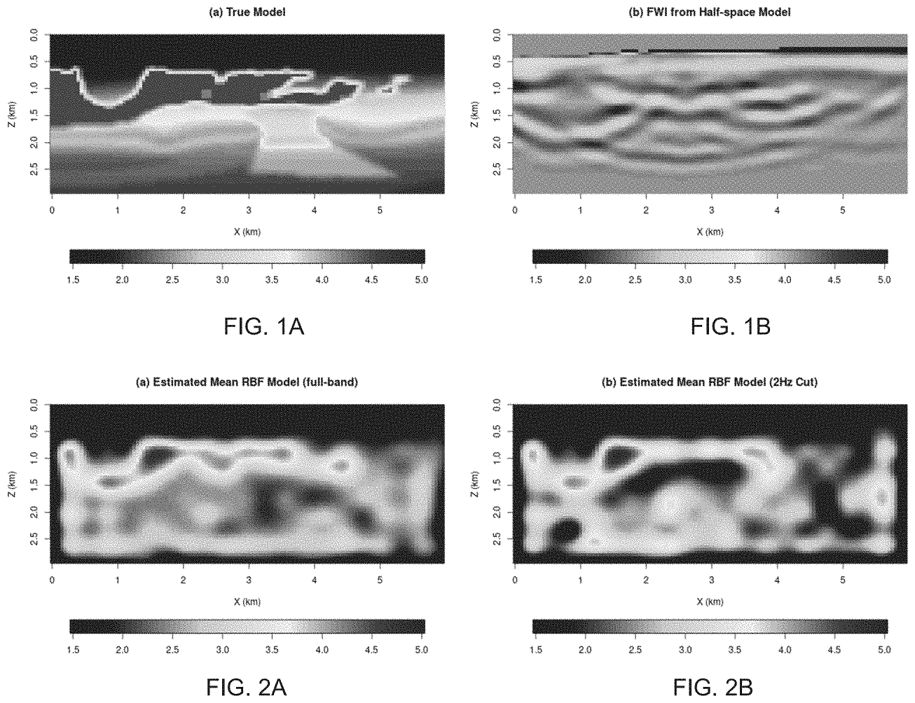

We demonstrate the capability of SWI for recovering the long wavelength structure using synthetic data generated for a reduced-size version of the standard BP salt model (FIG. 1A). The forward modeling runs for SWI used 120 by 60 grid points in x and z, and a 50 m grid spacing in both x and z. The SWI used a coarser 10 by 6 grid for the radial basis function parameterization.

The “observed” data was generated by finite difference time domain (FDTD) modeling with a 3 Hz Ricker wavelet, and a fixed spread acquisition consisting of eight sources and 240 receivers spaced evenly along the horizontal direction. The sources and receivers are positioned at 25 m and 50 m below the water surface accordingly. For this example, we did not add noise to the synthetic data.

The starting model for MCMC sampling is a water-over-half space model with the P-wave velocities of 1500 m/s and 2500 m/s, respectively. To obtain the equivalent starting model in the RBF domain, we performed a least-squares fit of the fine-scale starting model to the radial basis functions. MCMC sampling was then performed for 40,000 iterations We use Heidelberger and Welch's convergence diagnostic to check the convergence of the inverse variance and data misfits. While both diagnostics indicated convergence, convergence of multiple chains is a more robust diagnostic that we propose to use in future runs.

As a comparison, FIG. 1B shows the results of standard least-squares FWI starting from the half-space model. FIG. 2A shows the SWI estimated mean velocity model based on samples from iterations 20,000-40,000 when using full band seismic data; FIG. 2B shows the SWI estimated results when using band-limited (2-15 Hz) data. Comparing the estimated coarse-scale model with the corresponding true model (see FIG. 1A), we find that SWI recovers the long wavelength geometries of salt bodies, e.g., the presence of salt bodies at the upper-left area of the cross section and the missing of the salt bodies near the upper-right corner.

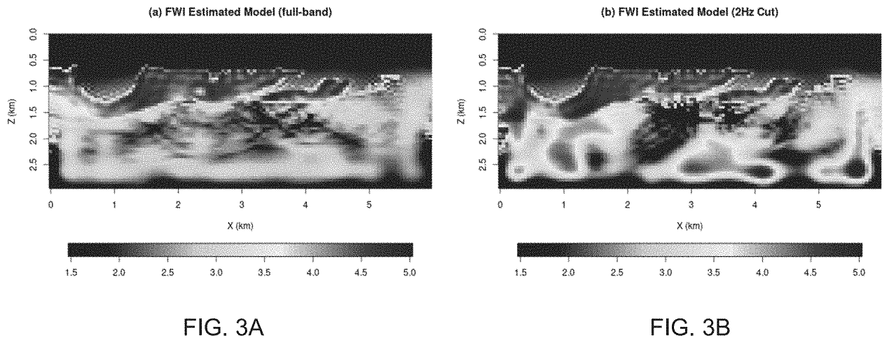

The objective of SWI in this application is to provide a non-cycle skipped starting model for conventional least-squares FWI. FIG. 3A and FIG. 3B compares conventional FWI using the two SWI estimated mean starting models. As expected, starting from a water-over-half space, standard FWI fails to find the salt bodies (see FIG. 1B). However, by starting from the SWI estimated mean models, FWI correctly identifies the salt bodies at a very high resolution (see FIG. 3A and FIG. 3B). Comparing to the true salt body model (FIG. 1A), the SWI-driven FWI underestimates the deep part of background models, indicating room for further adaptation of our SWI approach to focus on recovering the deeper portion of the model.

We have developed a Bayesian model with MCMC sampling and a sparse and smooth radial basis function model parameterization for estimating long-wavelength starting models for FWI. A 2D synthetic case salt model example shows that by starting from the mean SWI model, conventional waveform misfit FWI can correctly identify the high-resolution structure of salt bodies.

In this study, we use stochastic full waveform inversion (SWI) to complement conventional FWI by providing a non-cycle skipped long wavelength starting model for standard FWI. With current computational capabilities we postulate that the SWI objective of estimating long wavelength starting models for FWI is feasible in 3D for smaller models, assuming the number of forward modeling steps in 3D is similar to that for the 2D results shown here. Because SWI provides an ensemble of models that fit the data with model constraints, this long wavelength information will prove useful in model building workflows for seismic imaging and uncertainty analysis.

Although the embodiment above is directed to generating a long wavelength subsurface model, this is not intended to be limiting. SWI can also be used to generate a subsurface model representative of both long and short wavelength features. The subsurface model could then directly be used for seismic imaging.

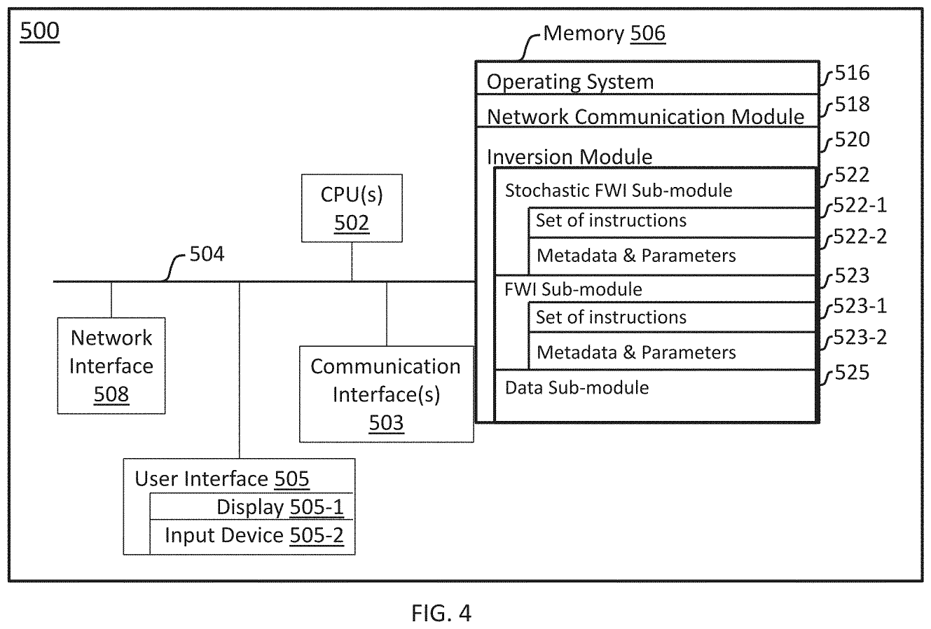

FIG. 4 is a block diagram illustrating a full waveform inversion system 500, including both stochastic full waveform inversion (SWI) and standard full waveform inversion (FWI), in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the full waveform inversion system 500 includes one or more processing units (CPUs) 502, one or more network interfaces 508 and/or other communications interfaces 503, memory 506, and one or more communication buses 504 for interconnecting these and various other components. The full waveform inversion system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store seismic data, velocity models, seismic images, and/or geologic structure information.

In some embodiments, memory 506 or the non-transitory computer readable storage medium of memory 506 stores the following programs, modules and data structures, or a subset thereof including an operating system 516, a network communication module 518, and an inversion module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the inversion module 520 executes the operations described above. Inversion module 520 may include data sub-module 525, which handles the seismic dataset. This seismic data is supplied by data sub-module 525 to other sub-modules.

Stochastic full waveform inversion (SWI) sub-module 522 contains a set of instructions 522-1 and accepts metadata and parameters 522-2 that will enable it to execute the operations needed to generate the long wavelength subsurface model. The full waveform inversion (FWI) sub-module 523 contains a set of instructions 523-1 and accepts metadata and parameters 523-2 that will enable it to execute standard FWI using the long wavelength subsurface model that estimated by SWI as a starting model. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing seismic data and generate a seismic image. For example, any of the sub-modules may optionally be able to generate a display that would be sent to and shown on the user interface display 505-1. In addition, any of the seismic data or processed seismic data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 4) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
a. receiving, at a computer processor, a seismic dataset representative of a subsurface volume of interest;
b. performing stochastic full waveform inversion of the seismic dataset to generate a long wavelength subsurface model;
c. performing full waveform inversion of the seismic dataset using the long wavelength subsurface model as a starting model to generate an improved subsurface model;
d. performing seismic imaging of the seismic dataset using the improved subsurface model to generate a seismic image; and
e. identifying geologic features based on the seismic image.

2. The method of claim 1 wherein the stochastic full waveform inversion includes at least one of low-dimensional model parameterization, a Bayesian model, and Markov Chain Monte Carlo (MCMC) sampling strategies.

3. The method of claim 2 wherein the low-dimensional model parameterization is selected from one of wavelet or other kernel basis parameterization, frequency domain parameterization, hierarchical parameterization with multiple types of auxiliary variables, or hybrid parameterization by combining different types of parameterization.

4. The method of claim 2 wherein the Bayesian model is based on a type of likelihood function that best describes information in the seismic dataset by using different transformation or preconditioning on the seismic dataset.

5. The method of claim 2 wherein the Markov Chain Monte Carlo sampling is a sampling method that will speed up convergence of chains selected from one of single-sit or blockwise Metropolis-Hastings sampling, slice sampling, Gibbs sampling, or parallelized Metropolis coupled Markov chain Monte Carlo sampling.

6. A computer-implemented method, comprising:
a. receiving, at a computer processor, a seismic dataset representative of a subsurface volume of interest;
b. performing stochastic full waveform inversion of the seismic dataset to generate a subsurface model;
c. performing seismic imaging of the seismic dataset using the improved subsurface model to generate a seismic image; and
d. identifying geologic features based on the seismic image.

7. A computer-implemented method, comprising:
a. receiving, at a computer processor, a seismic dataset representative of a subsurface volume of interest; and
b. performing stochastic full waveform inversion of the seismic dataset to generate a subsurface model.

8. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a seismic dataset representative of a subsurface volume of interest;
b. perform stochastic full waveform inversion of the seismic dataset to generate a long wavelength subsurface model;
c. perform full waveform inversion of the seismic dataset using the long wavelength subsurface model as a starting model to generate an improved subsurface model; and
d. perform seismic imaging of the seismic dataset using the improved subsurface model to generate a seismic image.

9. The system of claim 8 wherein the stochastic full waveform inversion includes at least one of low-dimensional model parameterization, a Bayesian model, and Markov Chain Monte Carlo (MCMC) sampling strategies.

10. The system of claim 9 wherein the low-dimensional model parameterization is selected from one of wavelet or other kernel basis parameterization, frequency domain parameterization, hierarchical parameterization with multiple types of auxiliary variables, or hybrid parameterization by combining different types of parameterization.

11. The system of claim 9 wherein the Bayesian model is based on a type of likelihood function that best describes information in the seismic dataset by using different transformation or preconditioning on the seismic dataset.

12. The system of claim 9 wherein the Markov Chain Monte Carlo sampling is a sampling method that will speed up convergence of chains selected from one of single-sit or blockwise Metropolis-Hastings sampling, slice sampling, Gibbs sampling, or parallelized Metropolis coupled Markov chain Monte Carlo sampling.

13. A non-transitory computer readable storage medium storing one or more programs, the one or more programs comprising instructions, which when executed by an electronic device with one or more processors and memory, cause the device to:
a. receive, at the one or more processors, a seismic dataset representative of a subsurface volume of interest;
b. perform stochastic full waveform inversion of the seismic dataset to generate a long wavelength subsurface model;
c. perform full waveform inversion of the seismic dataset using the long wavelength subsurface model as a starting model to generate an improved subsurface model; and
d. perform seismic imaging of the seismic dataset using the improved subsurface model to generate a seismic image.

14. The non-transitory computer readable storage medium of claim 13 wherein the stochastic full waveform inversion includes at least one of low-dimensional model parameterization, a Bayesian model, and Markov Chain Monte Carlo (MCMC) sampling strategies.

15. The non-transitory computer readable storage medium of claim 14 wherein the low-dimensional model parameterization is selected from one of wavelet or other kernel basis parameterization, frequency domain parameterization, hierarchical parameterization with multiple types of auxiliary variables, or hybrid parameterization by combining different types of parameterization.

16. The non-transitory computer readable storage medium of claim 14 wherein the Bayesian model is based on a type of likelihood function that best describes information in the seismic dataset by using different transformation or preconditioning on the seismic dataset.

17. The non-transitory computer readable storage medium of claim 14 wherein the Markov Chain Monte Carlo sampling is a sampling method that will speed up convergence of chains selected from one of single-sit or blockwise Metropolis-Hastings sampling, slice sampling, Gibbs sampling, or parallelized Metropolis coupled Markov chain Monte Carlo sampling.
